(19) United States
(12) Patent Application Publication
(10) Pub. No.: US 2014/0083464 A1
(43) Pub. Date: Mar. 27, 2014

(54) ASSEMBLY FOR IMPROVING REMOVAL FROM A PIPE OF DEBRIS SUCH AS ROOTS AND SCALE USING A WATER JET NOZZLE

(71) Applicant: Jim Paris, New South Wales (AU)

(72) Inventor: Jim Paris, New South Wales (AU)

(21) Appl. No.: 14/008,686

(22) PCT Filed: Mar. 31, 2012
(86) PCT No.: PCT/AU2012/000326

§ 371 Date: Dec. 9, 2013

(30) Foreign Application Priority Data
Mar. 31, 2011 (AU) 2011901187
Aug. 15, 2011 (AU) 2011903242

(51) Int. Cl. F16L 55/40

(52) U.S. Cl. CPC F16L 55/40
USPC 134/22.12; 134/167 C

(57) ABSTRACT

A carriage for receiving and retaining at least one water delivery nozzle. The carriage comprises a body defining a space which receives and retains therein the at least one water delivery nozzle. The carriage includes support means extending from the carriage body which when the carriage is inserted in a pipe engages an inner surface of the pipe. The carriage further comprises at least one formation which enables the nozzles to be disposed at a predetermined angle relative to the longitudinal axis of the pipe in which the carriage travels.

### BACKGROUND

The present invention relates to apparatuses for removing debris such as roots and scale build up from the inside of fluid pipes. More particularly the present invention relates to water nozzle carriage assemblies for use in high pressure water cleaning of the inside of pipes. The invention further relates to an assembly including a carriage for high pressure nozzles used in pipe cleaning and which enables adjustment the angular attitude of the nozzle and in particular the range of angles of attack of water jets which impact on an inner wall of a pipe or direction of water jets delivered from the nozzles. The invention relates to a method for cleaning the inside of fluid pipes by selective adjustment of the angle of delivery of water jets.

### PRIOR ART

Various apparatus and methods have been employed in the past for removing unwanted tree roots in water, sewerage or drainage pipes. Tree roots can destroy pipes and block the passage of water or sewage therethrough. Various pipe materials have been used in the past for sewerage, drainage and water reticulation networks. For sewage pipe networks materials such as cast iron, galvanised iron, clay and plastics have been used. The weakest part of a pipe network is usually the location of the pipe joins. Tree roots are opportunistic and are likely to be encountered where a pipe leaks, or at a faulty join. Water delivery pipes tend to be less susceptible to root penetration, as they are usually formed from continuous copper lines which have few joins. Drainage pipes which carry sewage or drainage water are particularly vulnerable to root penetration if a join is compromised, as roots can more easily detect the presence of water. Roots can also damage pipe joins and enter the pipe via that join. Plant and tree roots found in pipes are usually the fibrous variety. They can be very hard to dislodge especially as they are alive having been fed by water in the pipes.

Various apparatuses have been employed for root removal from pipes. One such method employs an electrically driven spinning cutter which is located on a free end of a long feed line. The feed line which is fed into a pipe, terminates at a drive motor and spins the feed line about a longitudinal axis and at the same time advancing the line along the pipe. As the cutters rotate and advance, they cut through roots and any other blockage. One problem with this method of root removal is that it is not assisted by water flushing unless an operator feeds a water supply hose into the pipe. The water in this instance plays no role in severing the roots but rather if used, it flushes cut roots downstream of the blockage. Other methods have been used such as feeding rods through a pipe and attempting to push the blockage away manually. Another method has been to feed a hose into the pipe and send high pressure water along the pipe in an attempt to flush the blockage. The use of rods and sending high pressure water along the pipe have only limited benefit and although they may be useful in removing a dry choke or amorphous mass soft choke which is not physically attached to the pipe, there is insufficient force available to sever roots which are often anchored from outside the pipe.

Fibrous roots are the most common cause of root blockage in a water carrying pipe such as a drainage or sewer pipe. These are fine roots which can enter a pipe from outside via a small crack in a pipe or in a pipe join. In some cases the roots can surround the outside of a pipe and eventually cause a breakage in the pipe in which case the opportunistic fibrous roots, grow into the pipe as they follow moisture. Tap roots are the lost likely to cause mechanical damage to the pipe and once that occurs the fibrous roots grow towards the moisture in the pipe. Once fibrous roots take hold, they can totally block the inside diameter of the pipe.

More recently, the plumbing industry has employed high pressure nozzles operating around 200 bar (5000 psi), which are fed into pipes on the end of a high pressure water supply line. The purpose of these nozzles is to deliver water at such high pressure that the roots inside the blocked pipe are eroded away by shredding or breaking. These high pressure nozzles are also used in de scaling of the internal surfaces of pipe in cases where build up of unwanted scale and other organic and mineral debris can reduce the effective diameter of the pipes and in extreme cases eventually block the pipe altogether. Typically, these high pressure nozzles have strategically placed openings which direct water in fine jets to create a high energy impact on a pipe wall to remove scale and mineral build up. Another known high pressure pipe cleaning nozzle includes a rotating head which has exit ports in the head disposed at various angles allowing the water to exit rearwardly, normally and ahead of the nozzle in its advancing direction. Typically the nozzles are placed in a carriage which allows the nozzle to slide along the bottom of the pipe as it advances. One of the disadvantages of the known nozzles is that the angles pre set in the nozzle body or rotating head cannot be adjusted or stabilised from the delivery angles which are available once the nozzle is inserted into the carriage. The carriage has fixed bearing legs which hold the nozzle just above the bottom of the pipe in which it is travelling.

The longitudinal axis of the nozzles will typically be parallel with the longitudinal axis of the pipe. There are no means currently available to adjust the attitude or orientation of the nozzle so as to optimise angles of water jet attack. The angle that the water jet impacts on its target will influence the efficiency of the water jet. For example, a water jet which exits normally from a nozzle will not have the same abrasive or cutting force compared to a water jet which approaches its target at an angle. The current tool is unstable, erratic and unpredictable.

There is a long felt want in the field to provide an improvement to the existing method using high pressure nozzles by providing means to enable a user to adjust the water jet angles to optimise surface abrasion for cleaning purposes and to enable selection of an optimal approach angle to enable the most efficient debridement and cutting of roots. Furthermore there is a need to provide an alternative apparatus which is simple to operate, is adaptable to existing water jet nozzles, does not require power, is inexpensive to manufacture, can be mass produced, is durable, takes up little space and requires a minimum of mental and physical effort to set up. There is also a need to provide an apparatus which allows a user to set the nozzle and bore so the water jet will impact on roots at a selected angle.

### Invention:

With the above shortcomings of the prior art in mind, the present invention provides an apparatus for removing debris such as roots and scale build up from the inside of fluid pipes using selectively angled nozzles. More particularly the present invention provides a water nozzle carriage assemblies for use in high pressure water cleaning of the inside of a pipe. The invention further provides an assembly including a carriage for high pressure nozzles used in pipe cleaning and which enables adjustment to the angular attitude of the nozzle and in particular the range of available angles of attack of water jets which impact on an inner wall of a pipe. The invention further provides a method for cleaning the inside of fluid pipes by selective adjustment of the angle at which water is delivered from the nozzle; the carriage further comprising support members which support the carriage against the pipe and manage angles and tracking. The invention further provides an assembly including a carriage for high pressure nozzles used in pipe cleaning and which enables carriage of back to back nozzles disposed at a selected attitude dictated by the geometry of the carriage. The carriage allows the nozzle or nozzles in the case of back to back nozzles to be orientated to present a water jet for optimal inner wall pipe cleaning. The invention further provides a method for cleaning the inside of fluid pipes by using a carriage which supports one or two nozzles which deliver a water jet.

In its broadest form the present invention comprises:

a carriage for receiving and retaining a water delivery nozzle, the carriage comprising:
a body defining a space which receives and retains therein the water delivery nozzle,
adjustable members associated with the carriage body enable selective adjustment of the attitude of the delivery nozzles. According to a preferred embodiment the adjustable members engage the carriage and are repositionable to enable alteration of the angular relationship between a longitudinal axis of the pipe and a longitudinal axis of the nozzle.

According to one embodiment the angle selection apparatus contributes to nozzle tracking. Throughout the specification a reference to adjustable can be taken to include removable, re positionable and any form of adjustment which results in a change in attitude of the longitudinal axis of the nozzle relative to the longitudinal axis of the pipe.

In another broad form the present invention comprises:

a carriage for receiving and retaining a water delivery nozzle, the carriage comprising:
a body defining a space which receives and retains therein the water delivery nozzle,
the carriage further comprising adjustable/replacable legs connected to the carriage body which enable selective extension and retraction of each leg to contribute to adjustment of the angle of impact of water jets emanating from the nozzle. Extension and retraction can be achieved in a variety of ways including but not limited to rotation, extension and re positioning. Lateral stability can be enhanced by leg adjustment.

In another broad form the present invention comprises:

an assembly for use in the removal of debris, roots and other unwanted matter from the inside of a fluid pipe, the assembly comprising:
a water delivery nozzle,
a carriage for receiving and retaining a water delivery nozzle, the carriage comprising:
a carriage body defining a space which receives and retains therein the water delivery nozzle,
adjustable members associated with the carriage body enabling selective adjustment of the attitude of the delivery nozzles to thereby enable selection of an optimal angle of impact of a water jet exiting the nozzle onto debris to be removed from the pipe.

Preferably the nozzle is a high pressure water delivery nozzle which can include nozzles of a known type. According to a preferred embodiment the adjustable members engage the carriage and are repositionable to enable alteration of the angular relationship between a longitudinal axis of the pipe and a longitudinal axis of the nozzle.

According to a preferred embodiment the adjustable members engage the carriage and are repositionable to enable alteration of the angular relationship between a longitudinal axis of the pipe and a longitudinal axis of the nozzle.

In another broad form of a method aspect the present invention comprises:

a method of removing debris from the inside of a fluid pipe using a high pressure water jet nozzle including;
a carriage for receiving and retaining the water delivery nozzle, the carriage comprising:
a carriage body defining a space which receives and retains therein the water delivery nozzle,
adjustable members associated with the carriage body enabling selective adjustment of the attitude of the delivery nozzle;
the method comprising the steps of
a) taking the carriage and inserting a selected nozzle into the carriage;
b) selecting an attitude from the nozzle but selective adjustment to the adjustable members
c) placing the assembly inside a pipe and activating a water supply to the nozzle;
wherein the selected attitude of the nozzle delivers water towards an inside surface of the pipe at an angle dictated by the selected attitude.

The angle at which the water jets are delivered to the pipe is preferably selected to optimise the angle of attack of the debris sought to be removed.

The carriage may be manufactured from metals fit for the purpose or in a mould from a flexible plastics material which may be selected from materials including polypropylene, polyethylene, rubbers including silicon. Preferably, the material is sufficiently stiff to ensure that the nozzle is maintained in the correct attitude. The weight of the carriage must be balanced so the carriage stays in equilibrium irrespective of the setting of the carriage assembly. The carriage can be set at or near the invert of a pipe which is usually the opposite side that roots penetrate the pipe.

In its broadest form the present invention comprises:

a carriage for receiving and retaining a water delivery nozzle, the carriage comprising:
a body defining a space which receives and retains therein at least one water delivery nozzle,
a saddle which receives and retains the nozzles on the carriage,
a bearing surface on the carriage which allows the carriage to travel along a pipe invert during discharge of water from the at least one nozzles.

In another broad form the present invention comprises:

a carriage for receiving and retaining at least one water delivery nozzle, the carriage comprising:
a body defining a space which receives and retains therein the at least one water delivery nozzle,
a saddle to retain the nozzles and support means associated with the carriage body to enable the carriage to move along a pipe invert; wherein the carriage further comprises a formation which enables the nozzles to be disposed at a predetermined angle relative to the longitudinal axis of the pipe in which the carriage travels.

In another broad form the present invention comprises:

an assembly for use in the removal of debris, roots and other unwanted matter from the inside of a fluid pipe, the assembly comprising:
a water delivery nozzle,
a carriage for receiving and retaining a water delivery nozzle, the carriage comprising:
a carriage body defining a space which receives and retains therein the water delivery nozzle,
a formation associated with the carriage body enabling the nozzle to be disposed in a fixed attitude so that water exiting the nozzle impacts on the inside wall of a pipe at an optimal angle onto debris to be removed from the pipe.

Preferably the nozzle is a high pressure water delivery nozzle which can include nozzles of a known type. According to a preferred embodiment the carriage has a geometry which enables a fixed angular relationship between a longitudinal axis of the pipe and a longitudinal axis of the nozzle.

In another broad form of a method aspect the present invention comprises:

a method of removing debris from the inside of a fluid pipe using a high pressure water jet nozzle assembly comprising;
a carriage for receiving and retaining at least one water delivery nozzle, the carriage comprising:
a carriage body defining a space which receives and retains therein the at least one water delivery nozzle,
a formation on the body allowing the at least one nozzles to be oriented in a predetermined attitude relative to a longitudinal axis of the pipe to thereby allow water to be delivered at predetermined angle;
the method comprising the steps of
a) taking the carriage and inserting at least one nozzle into the carriage so that the at least one nozzle lies at the predetermined angle;
b) placing the assembly inside a pipe and activating a water supply to the nozzle; wherein the selected attitude of the nozzle delivers water towards an inside surface of the pipe at an angle dictated by the selected attitude.

The angle at which the formation in the carriage allows water jets to be delivered to the pipe is preferably selected by arranging the formation to optimise the angle of attack of water against the debris sought to be removed.

The carriage may be manufactured from metals fit for the purpose or in a mould from a flexible plastics material which may be selected from materials including polypropylene, polyethylene, rubbers including silicon. Preferably, the material is sufficiently stiff to ensure that the nozzle is maintained in the correct attitude. The weight of the carriage must be balanced so the carriage stays in equilibrium irrespective of the setting of the carriage assembly. The carriage can be set at or near the invert of a pipe which is usually the opposite side that which roots penetrate the pipe.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practised. These embodiments will be described in sufficient detail to enable those skilled in the art to practise the invention, and it is to be understood that other embodiments may be utilized and that structural changes may be made without departing from the scope of the invention. In the accompanying illustrations, like reference characters designate the same or similar parts throughout the several views.

The following detailed description is, therefore, not to be taken in a limiting sense, and the scope of the present invention is best defined by the appended claims.

### BRIEF DESCRIPTION OF DRAWINGS

FIG. 1 shows a side elevation view of an assembly according to one embodiment.

FIG. 2 shows a cross sectional view of an assembly according to one embodiment with four removable legs and mounted in a pipe also shown in cross section.

FIG. 3 shows a cross sectional view of an assembly according to an alternative embodiment with two removable legs and mounted in a pipe also shown in cross section.

FIG. 4 shows a cross sectional view of an assembly according to another embodiment with two adjustable legs and mounted in a pipe also shown in cross section.

FIG. 5 shows a cross sectional view of an assembly according to an alternative embodiment with an alternative carriage and four adjustable legs and mounted in a pipe also shown in cross section.

FIG. 6 shows a cross sectional view of an assembly according to an alternative embodiment with an alternative carriage and three adjustable legs and mounted in a pipe also shown in cross section.

FIG. 7 shows a long sectional view through a pipe and debris removal assembly therein with the assembly disposed at an angle to the longitudinal axis of a pipe of 85 mm diameter and showing an impact distance from nozzle exit.

FIG. 8 shows a long sectional view through a pipe and debris removal assembly therein with the assembly disposed at an angle to the longitudinal axis of a pipe of 103 mm diameter and showing an impact distance from nozzle exit.

FIG. 9 shows a long sectional view through a pipe and debris removal assembly therein with the assembly disposed at an angle to the longitudinal axis of a pipe of 152 mm diameter and showing an impact distance from nozzle exit.

FIG. 10 shows a perspective view of a carriage assembly according to one embodiment.

FIG. 11 shows a perspective view of a carriage assembly holding two opposing high pressure water jet nozzles according to an alternative embodiment.

FIG. 12 shows a plan view of the carriage assembly of FIG. 2 according to an alternative embodiment with fixed attitude formation.

FIG. 13 shows the assembly of FIG. 3 from a side elevation and rotated 90 degrees.

FIG. 14 shows a perspective view of a carriage according to an alternative embodiment.

FIG. 15 shows an alternative perspective view of the embodiment of FIG. 14.

FIG. 16 shows an end elevation view of the carriage of FIG. 14; and

FIG. 17 shows a cross section through A-A of FIG. 17.

### DETAILED DESCRIPTION

The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description.

Throughout the specification a reference to a carriage can be taken to mean a device which receives and retains the water nozzle and which includes an opening in which the nozzle is inserted and also which in respect to the invention allows selective adjustment of the repose angle of the carriage relative to a longitudinal axis of the pipe in which the carriage is inserted.

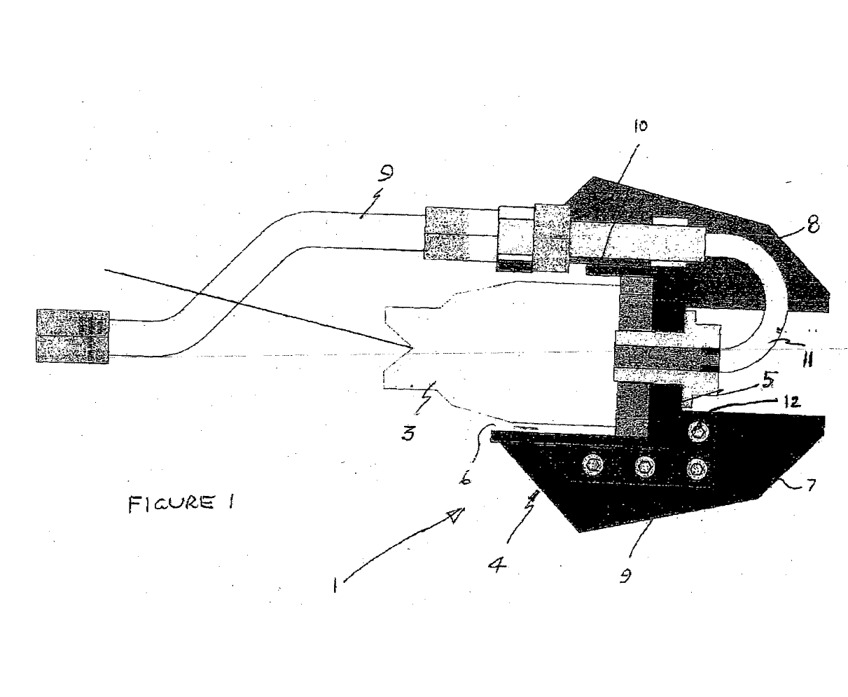

FIG. 1 shows a side elevation view of an assembly 1 for use in the removal of debris, roots and other unwanted matter from the inside of a fluid pipe. Assembly 1 comprises a water delivery nozzle 3, a carriage 4 for receiving and retaining water delivery nozzle 3. The carriage 4 comprises a carriage body 5 defining a space 6 which receives and retains therein the water delivery nozzle 3. Assembly 1 further comprises adjustable members 7 and 8 associated with carriage body 5. Adjustable members 7 and 8 are preferably detachably fixed to respective carriage support legs 9 and 10 and enable selective adjustment of the attitude of the delivery nozzles to enable selection of an optimal angle of impact of a water jet exiting the nozzle 3 onto debris to be removed from an internal surface of a pipe in which assembly 1 is located. Nozzle 3 is a high pressure water delivery nozzle which can include nozzles of a known type. According to a preferred embodiment the adjustable members 7 and 8 engage the carriage and are repositionable to enable alteration of the angular relationship between a longitudinal axis of the pipe and a longitudinal axis of the nozzle. This enables water jets emanating from the nozzle to be disposed at a desired angle. Nozzle 3 is fed water through supply line 9 which engages nozzle 3 via a return portion 11. This arrangement allows debris cut or abraded by the water jets to travel in a direction opposite to the direction of feed of the assembly 1 into the pipe. This stops the advancing assembly from becoming clogged with removed debris and/or roots and ensures that the advancing assembly is not obstructed. Adjustable member 7 as shown is secured via bolts 12 to carriage body 5. Adjustable member 8 is welded. Typically in use a front nozzle cuts a hole in a root clump and a back nozzle cuts the remaining roots and washes away the debris.

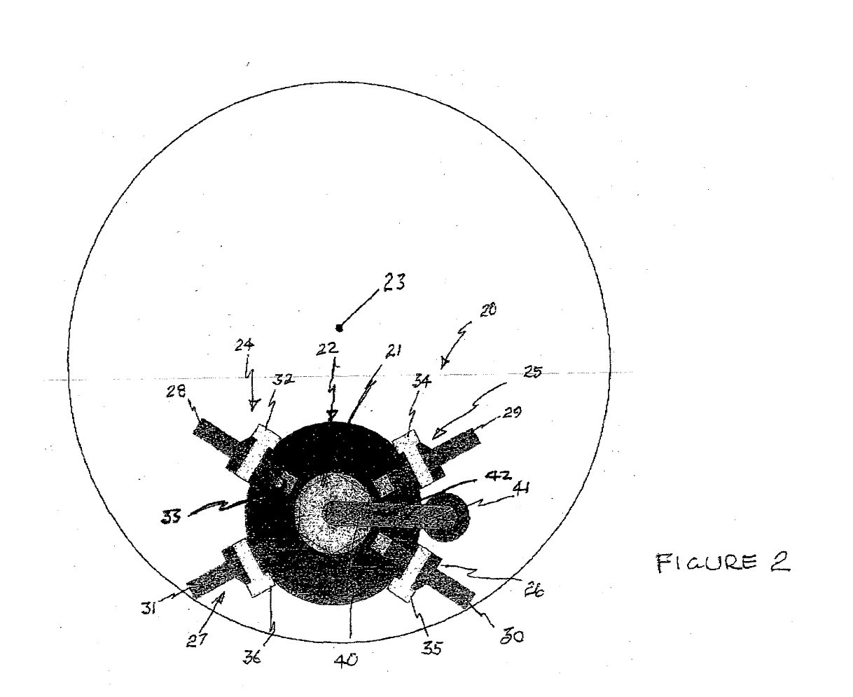

FIG. 2 shows a cross sectional view of an assembly 20 according to another embodiment. Assembly 20 comprises a water delivery nozzle 21, a carriage 22 for receiving and retaining water delivery nozzle 21. The carriage 22 comprises a carriage body opening which receives and retains therein the water delivery nozzle 21. Assembly 20 further comprises adjustable assemblies 24, 25, 26 and 27 which respectively receive and retain adjustable legs 28, 29, 30 and 31. Leg 28 is retained by bolt 32 and is capable of movement within recess 33. Likewise legs 29, 30 and 31 are respectively retained by bolts 34, 35 and 36 and operate in a similar manner to that described with respect to leg 28. Legs 28, 29, 30 and 31 enable selective adjustment of the attitude of the delivery nozzles to enable selection of an optimal angle of impact of a water jet exiting the nozzle 21. Adjustable legs 28, 29, 30 and 31 are repositionable to enable alteration of the angular relationship between a longitudinal axis of the pipe indicated by dot 23 and a longitudinal axis of the nozzle. This enables water jets emanating from the nozzle to be disposed at a desired angle. Nozzle 21 is fed water through supply line 40 which engages nozzle 21 via a return portion 41. This stops the advancing assembly from becoming clogged with removed debris and/or roots and ensures that the advancing assembly is not obstructed. Arrow 42 shows water direction through line 40.

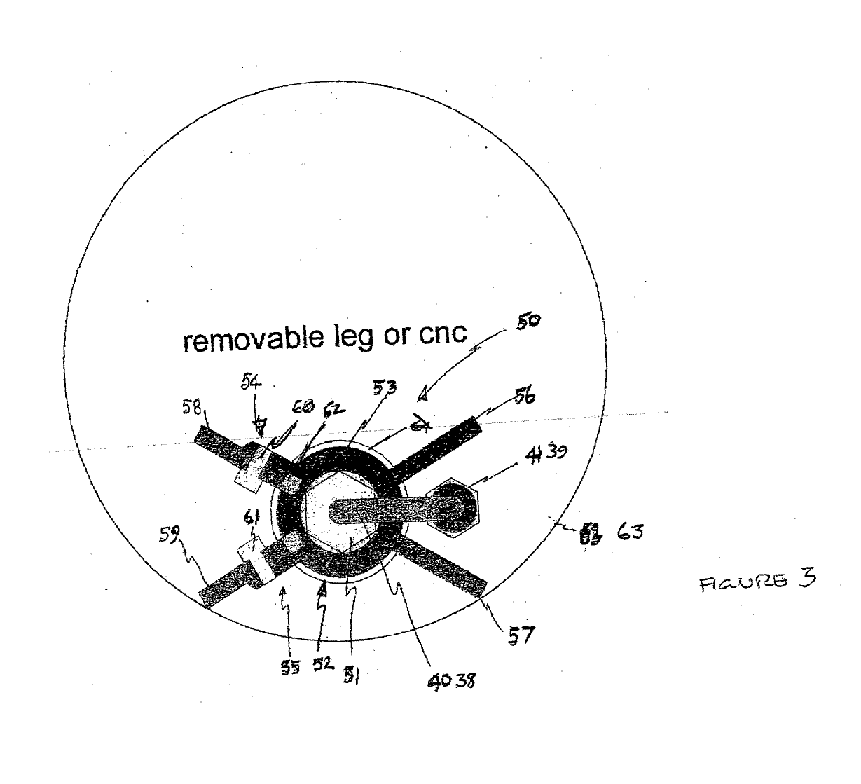

FIG. 3 shows a cross sectional view of an assembly 50 according to an alternative embodiment with two removable legs and mounted in a pipe 63 also shown in cross section. Assembly 50 comprises a water delivery nozzle 51, a carriage 52 for receiving and retaining water delivery nozzle 51. The carriage assembly includes a carriage body 53 receives and retains therein the water delivery nozzle 51. Assembly 50 further comprises adjustable members 54 and 55 which respectively receive and retain adjustable legs 58 and 59. Non adjustable members are 56 and 57. Adjustable members 58 and 59 are retained by bolts 60 and 61. Leg 58 is retained by bolt 60 and is capable of movement within slot 62. Likewise leg 59 is retained by bolt 61. This operates in a similar manner to that described with respect to leg 58. Legs 58 and 59, enable selective adjustment of the attitude of the delivery nozzle 51 to enable selection of an optimal angle of impact of a water jet exiting the nozzle 51. Carriage body is repositionable to enable alteration of the angular relationship between a longitudinal axis of the pipe and a longitudinal axis of the nozzle 51. This enables water jets emanating from the nozzle to be disposed at a desired angle. Nozzle 51 is fed water via supply line 38 which engages nozzle 51 via a return portion 39.

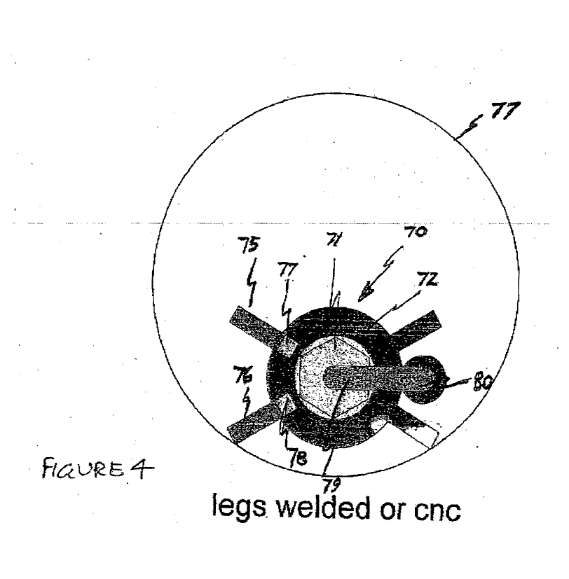

FIG. 4 shows a cross sectional view of an assembly 70 according to an alternative embodiment with two welded legs and mounted in a pipe also shown in cross section. Assembly 70 is mounted in pipe 77 and comprises a water delivery nozzle 71, a carriage 72 for receiving and retaining water delivery nozzle 71. Carriage 72 includes two welded legs 73 and 74 and adjustable legs 75 and 76. Adjustable legs 75 and 76 are retained by friction grip, or bolting as required. Legs 75 and 76 are adjustable in respective slots 77 and 78. Legs 75 and 76, enable selective adjustment of the attitude of the carriage 72 to enable selection of an optimal angle of impact of a water jet exiting the nozzle 71. Carriage 72 is repositionable to enable alteration of the angular relationship between a longitudinal axis of the pipe and a longitudinal axis of the nozzle 71. This enables water jets emanating from the nozzle to be disposed at a desired angle. Nozzle 71 is fed water via supply line 79 which engages nozzle 71 via a return portion 80.

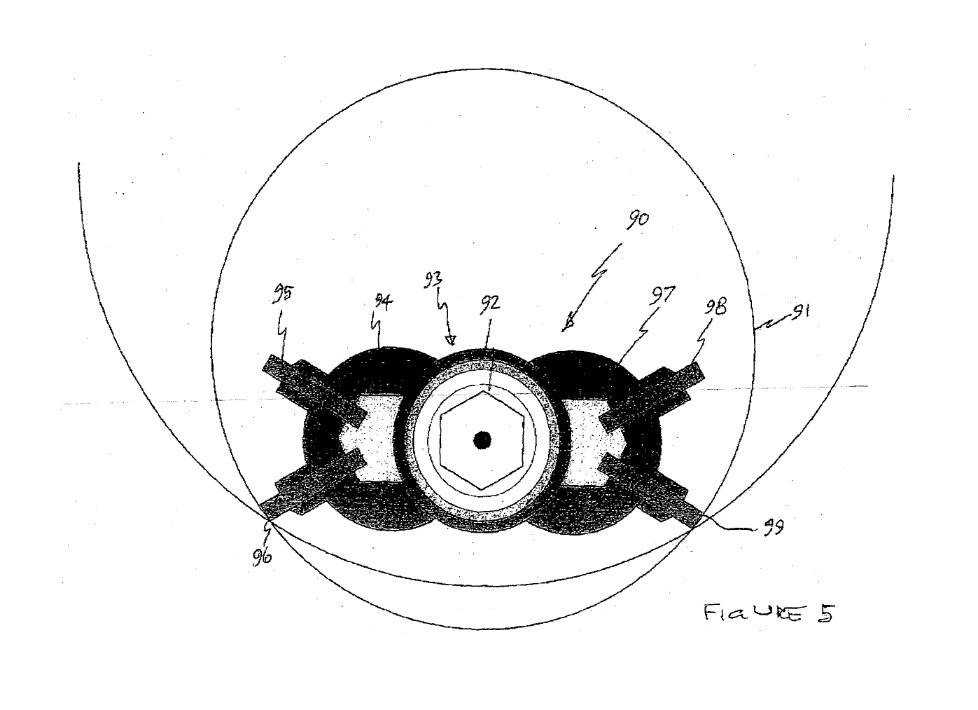

FIG. 5 shows a cross sectional view of an assembly 90 according to another embodiment with four adjustable legs and mounted in a pipe also shown in cross section. Assembly 90 is mounted in pipe 91 and comprises a water delivery nozzle 92, a carriage 93 for receiving and retaining water delivery nozzle 92. Carriage 93 includes body part 94 to which is connected adjustable legs 95, and 96 and body part 97 to which is connected legs 98 and 99. Adjustable legs 95, 96, 98 and 99 are retained by bolting or by friction grip, as required and are adjustable to enable selection of the attitude of the carriage 93 to enable selection of an optimal angle of impact of a water jet exiting the nozzle 92. Carriage 93 is repositionable to enable alteration of the angular relationship between a longitudinal axis of the pipe and a longitudinal axis of the nozzle 92. This enables water jets emanating from the nozzle to be disposed at a desired angle.

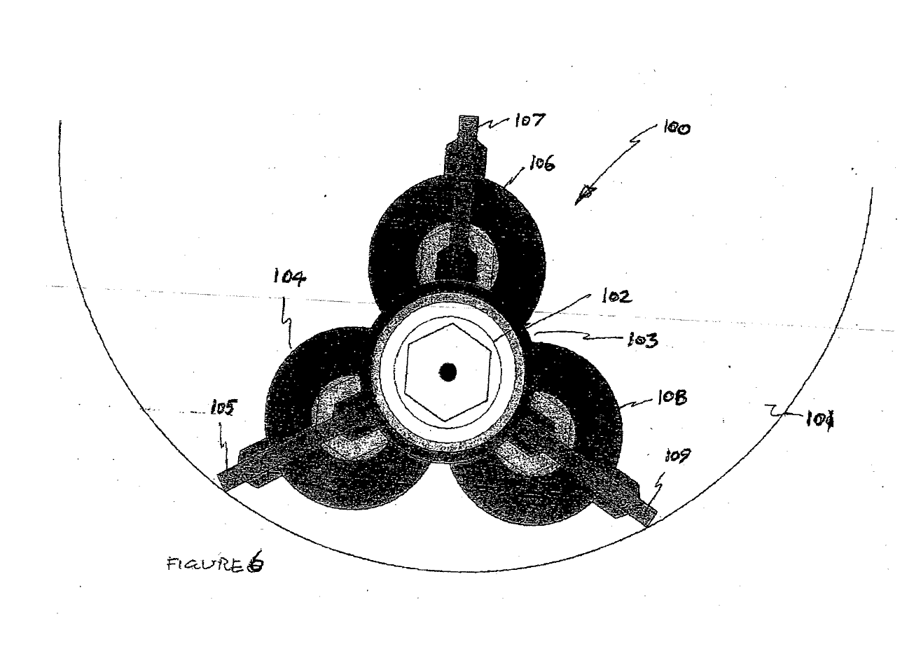

FIG. 6 shows a cross sectional view of an assembly 100 according to an alternative embodiment. Assembly 100 is mounted in pipe 101 and comprises a water delivery nozzle 102, a carriage 103 for receiving and retaining water delivery nozzle 102. Carriage 103 includes body part 104 to which is connected adjustable leg 105, body part 106 to which is connected adjustable leg 107 and body part 108 to which is connected adjustable leg 109. Adjustable legs 105, 106, 107 and 108 are retained by bolting or by friction grip, as required and are adjustable to enable selection of the attitude of the carriage 103 to enable selection of an optimal angle of impact of a water jet exiting the nozzle 102.

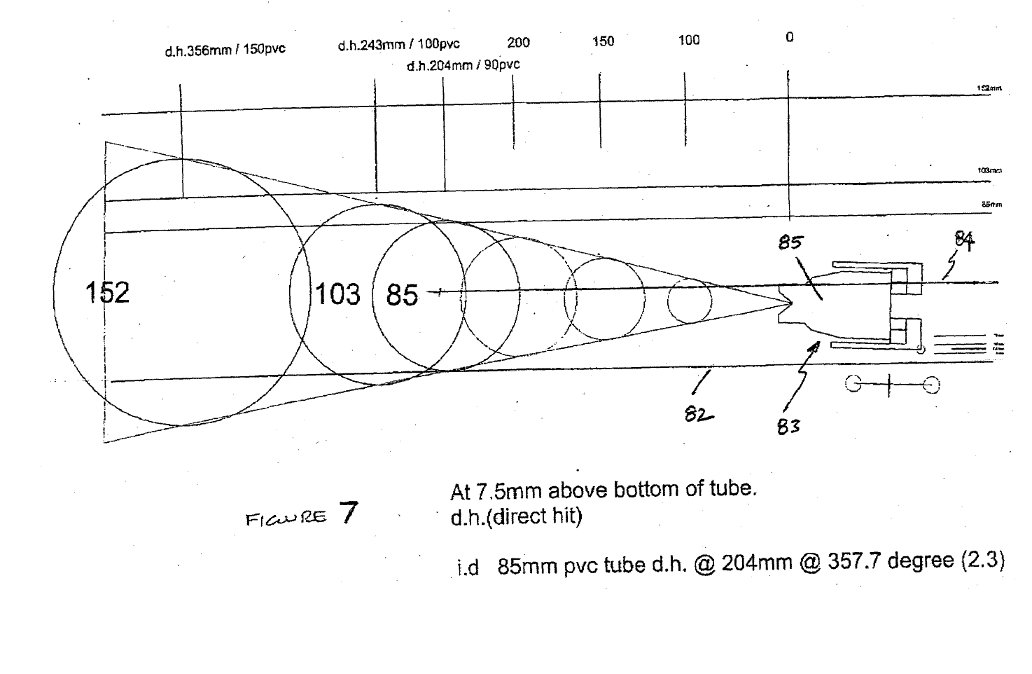

FIG. 7 shows a long sectional view through a pipe 82 and debris removal assembly 83 therein with the assembly disposed at an angle to the longitudinal axis 84 of a pipe 82. Pipe 82 is shown with a diameter of 85 mm. In the embodiment shown, the inner wall receives the full spray circle at approximately 200 mm impact distance from the outlet of nozzle 85. Nozzle 85 is located in carriage 86 which can be adjusted to alter the attitude of nozzle 85. Nozzle 85 can be any nozzle including a turbo type nozzle.

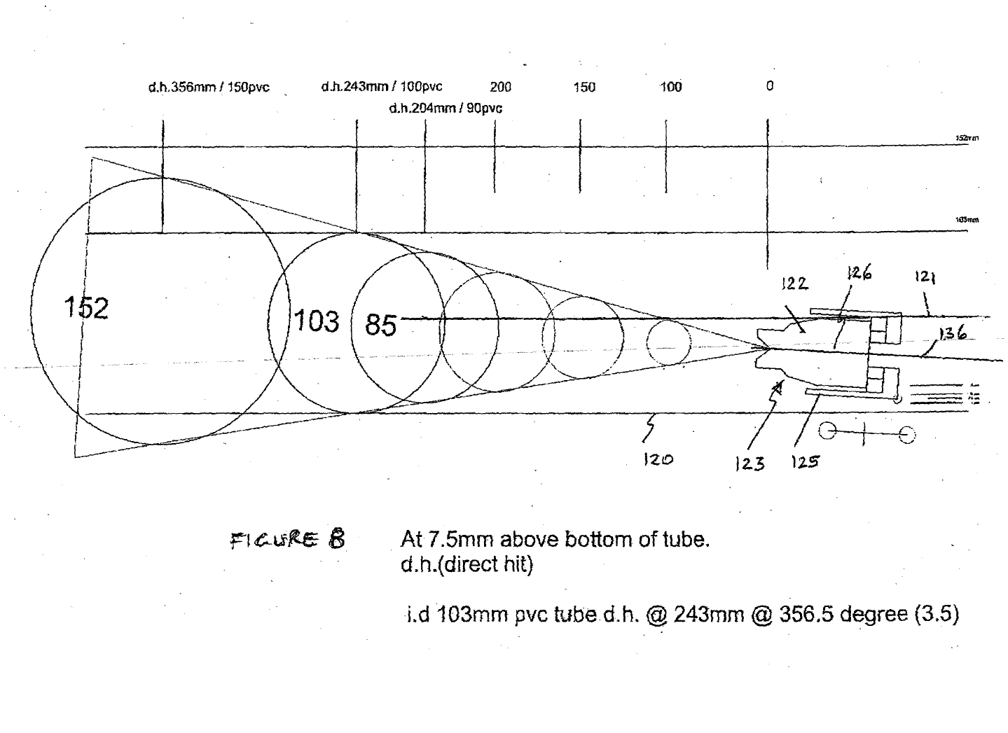

FIG. 8 shows a long sectional view through a pipe 120 and debris removal assembly 123 therein with the assembly disposed at an angle to the longitudinal axis 121 of a pipe 120 relative to axis 126 of nozzle 122. Pipe 120 is shown with a diameter of 103 mm. In the embodiment shown, the inner wall receives the full spray circle at approximately 243 mm impact distance from the outlet of nozzle 122. Nozzle 122 is located in carriage 125 which can be adjusted to alter the attitude of nozzle 122.

FIG. 9 shows a long sectional view through a pipe 130 and debris removal assembly 131 therein with the assembly disposed at an angle to the longitudinal axis 132 of a pipe 130 relative to axis 136. Pipe 130 is shown with a diameter of 152 mm. In the embodiment shown, the inner wall receives the full spray circle at approximately 356 mm impact distance from the outlet of nozzle 133. Nozzle 133 is located in carriage 134 which can be adjusted to alter the attitude of nozzle 133.

It can be seen from FIGS. 7, 8, 9 that if the direction of the water jet emanating from a nozzle is angled relative to a longitudinal axis of the pipe in which the nozzle is located, the impact on the inner surface of the pipe wall or on any roots or other debris extending from that wall will be earlier and greater in comparison to a nozzle disposed such that its longitudinal axis is parallel to the longitudinal axis of the pipe. Various means for enabling an adjustment to the angle of repose of the carriage have been described above but it will be appreciated that other means can be employed to enable an elevation of the outlet of the nozzle to achieve the improved energy of contact and earlier contact with debris, scale and other unwanted material. The user is able to set the carriage legs so that when the nozzle is inserted into the carriage the exit of the nozzle will be pointing at an angle selected from the particular job. A camera can be inserted into the pipe to make an assessment of an appropriate location of water jet impact and therefore the best angle of repose for the carriage to achieve the optimal contact for the particular job.

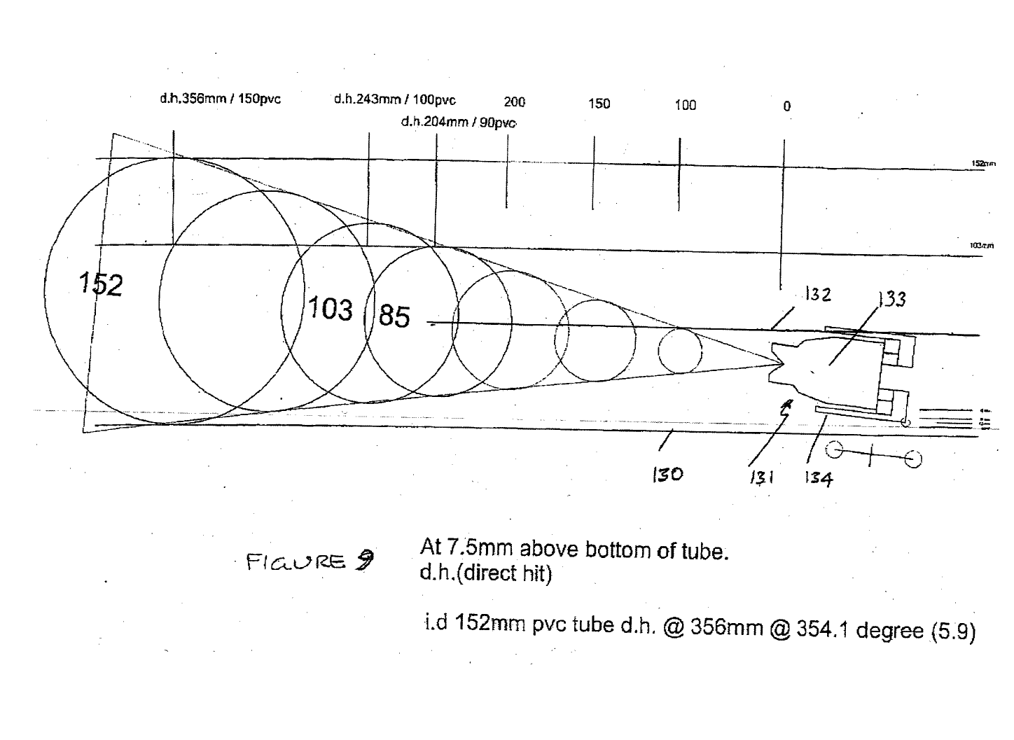

FIG. 10 shows a perspective view of a carriage assembly 140 according to one embodiment for use in the removal of debris, roots and other unwanted matter from the inside of a fluid pipe. Assembly 140 comprises a water delivery nozzle 143, a carriage 142 for receiving and retaining water delivery nozzle 143. The carriage 142 comprises a carriage body 144 defining a space 145 defined by saddle 146. which receives and retains therein the water delivery nozzle 143. Carriage 142 enables nozzle to be disposed in a predetermined orientation relative to a longitudinal axis of a pipe (not shown). Nozzle 143 is preferably detachably fixed to carriage. According to this embodiment, when the carriage is located on a pipe invert, water is delivered via orifice 147 along the pipe so that the water jet forms a cleaning circumference such that the attitude allows selection of an optimal angle of impact of a water jet exiting the nozzle via orifice 147 and which is generally normal to the longitudinal axis of the pipe. Nozzle 143 is a high pressure water delivery nozzle which can include nozzles of a known type. Nozzle 143 is fed water through supply line (not shown) which engages nozzle 143. This arrangement allows debris cut or abraded by the water jets to travel in a direction opposite to the direction of feed of the assembly 141 into the pipe. This stops the advancing assembly from becoming clogged with removed debris and/or roots and ensures that the advancing assembly is not obstructed. Typically in use a front nozzle cuts a hole in a root clump and a back nozzle cute the remaining roots and washes away the debris of going upstream washes away the debris.

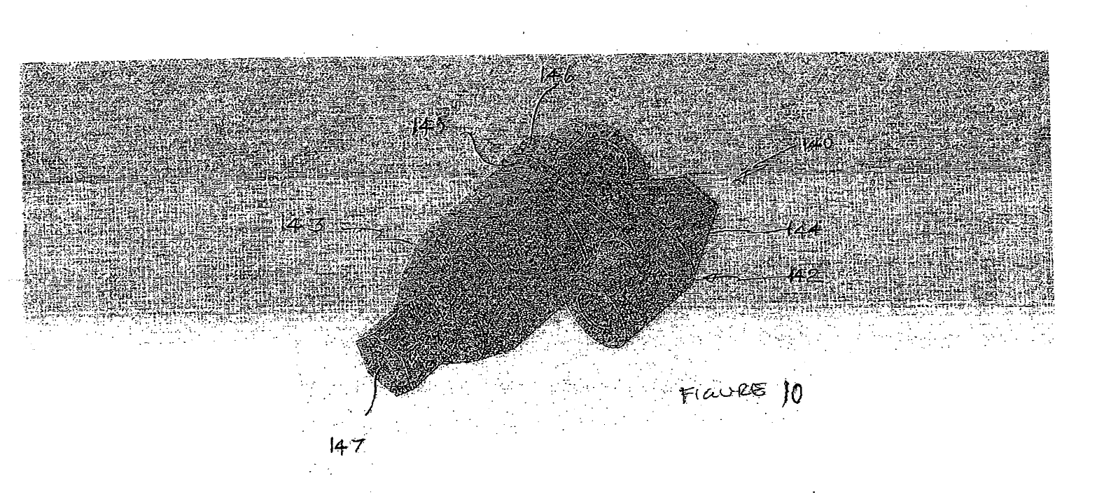

FIG. 11 shows a perspective view of the carriage assembly 240 according to an alternative embodiment. Assembly 240 comprises a first water delivery nozzle 241 and a second nozzle 242 both of which are mounted on a carriage 243. Carriage 243 comprises a carriage body 244 defining a space 245 defined by saddle 246 which receives and retains therein the water delivery nozzles 241 and 242. Carriage 243 enables nozzles 241 and 242 to be disposed in a predetermined orientation relative to a longitudinal axis of a pipe 247. Nozzles 41 and 242 are preferably detachably fixed to carriage 243. According to this embodiment, when the carriage is located on a pipe invert, water is delivered via orifice 248 of nozzle 241 and orifice 249 of nozzle 242.

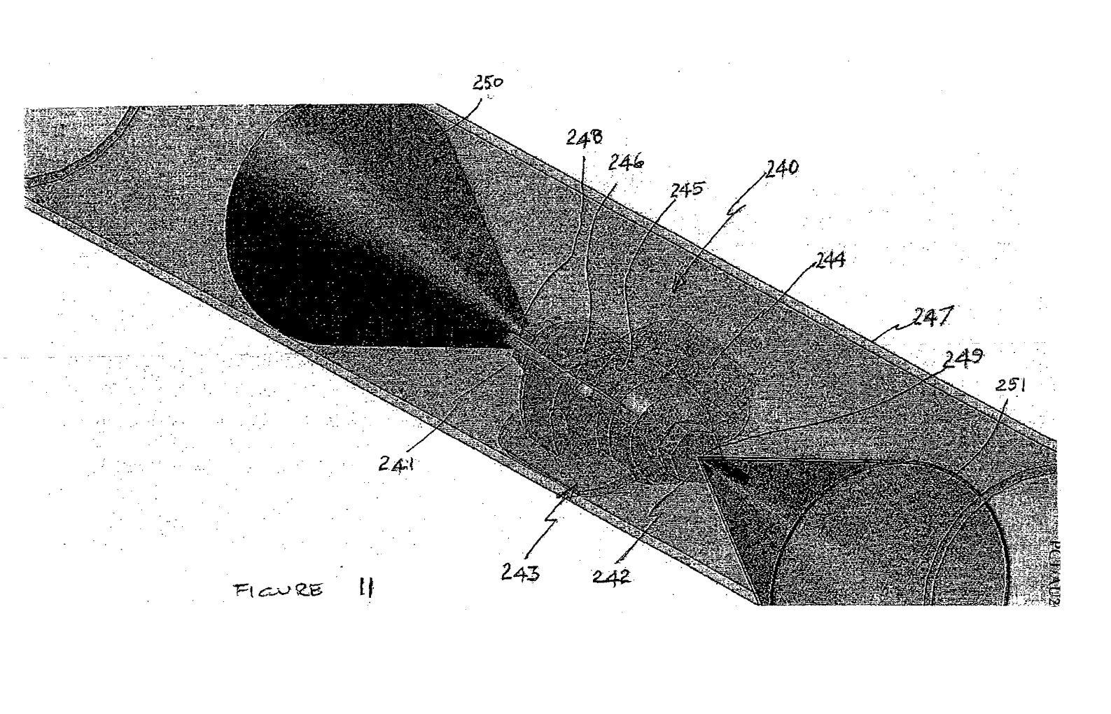

FIG. 12 shows with corresponding numbering, a plan view of the carriage assembly of FIG. 11 according to an alternative embodiment with fixed attitude formation. Assembly 240 when in a transverse plane, lies parallel to a longitudinal axis of pipe 47. Nozzles 241 and 242 deliver respective water jets 250 and 251 in opposite directions so that as carriage 240 moves along the pipe 247, the water jets form a cleaning circumference with the carriage geometry dictating the angle of attack relative to the pipe wall. Nozzles 241 and 242 are high pressure water delivery nozzles which can include nozzles of a known type. This arrangement allows debris cut or abraded by the water jets to be cut and flushed as the carriage moves through the pipe. This stops the assembly from becoming clogged with removed debris and/or roots and ensures that the assembly is not obstructed.

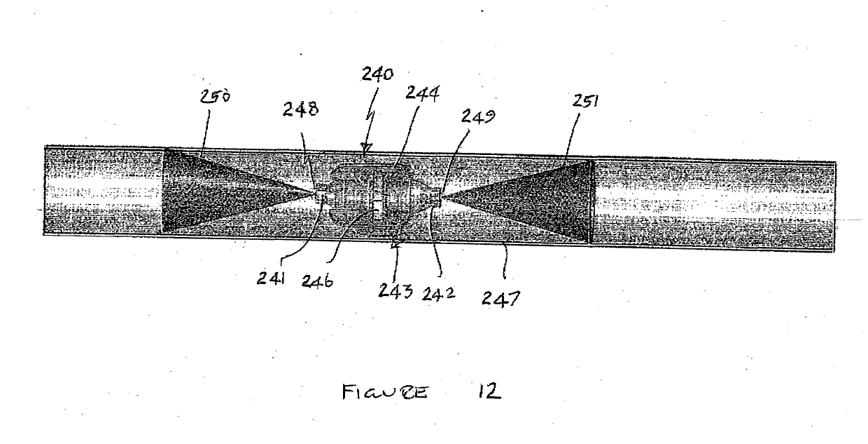

FIG. 13 shows with corresponding numbering the assembly of FIG. 12 from a side elevation and rotated ninety degrees. Assembly 240 when viewed from the side reveals that a line drawn through each nozzle exit is disposed at an angle relative to the longitudinal axis of the pipe This has be effect of altering the water contact circumference for each nozzle on the inside wall of the pipe in a vertical plane as shown in FIG. 12. Nozzles 241 and 242 deliver respective water jets 250 and 251 in opposite directions so that as carriage 240 moves along the pipe 247, the water jets form a cleaning circumference 252 which contacts the whole internal periphery of the pipe and a second downwardly directed circumference 253 which contacts part of the internal surface 254 of the pipe. The downwardly directed jet 251 in this instance does not contact upper surface 254 of pipe 247. It can be seen from FIG. 13 that if the direction of the water jets 250 and 251 emanating from respective nozzles 241 and 242 is set relative to a longitudinal axis of the pipe 247 in which the nozzle is located, it will impact of the location and extent of the circumferential rings and on the inner surface 254 of the pipe wall.

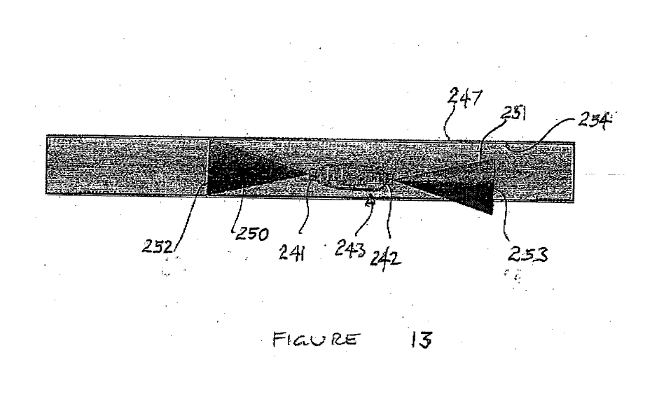

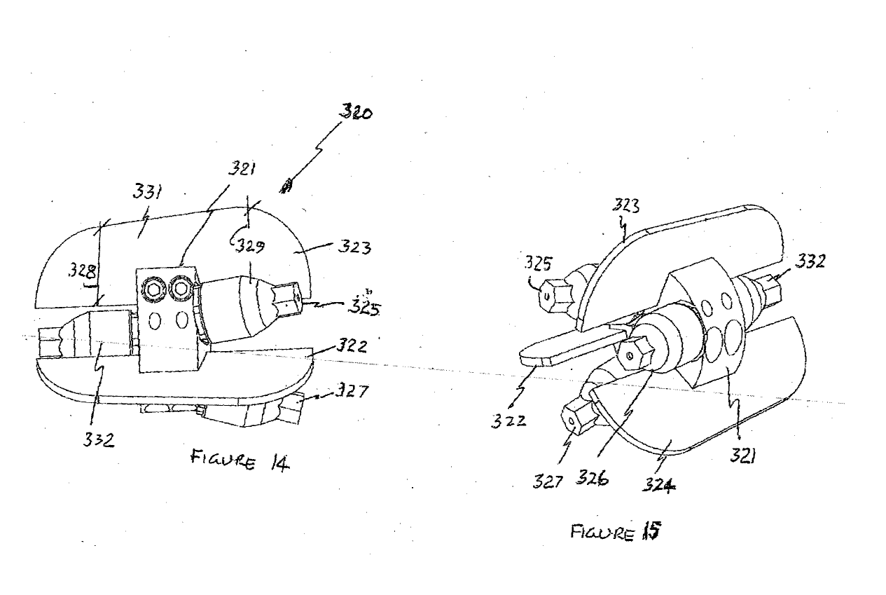

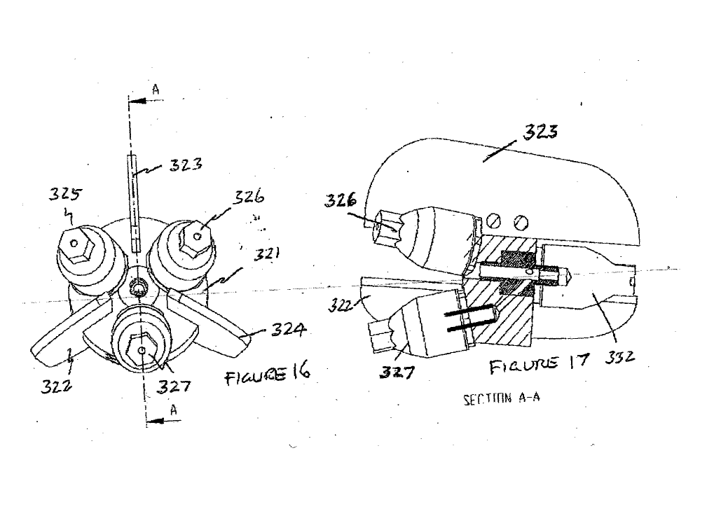

FIG. 14 shows a perspective view of a carriage according to an alternative embodiment. Referring to FIG. 14 there is shown a carriage 320 including a carriage body 321 from which extend fins 322, 323 and 324 preferably disposed at 320 degree spacing (best shown in FIG. 16). It will be appreciated by persons skilled in the art that the fin spacing can be altered according o particular requirements. Alternative fin spacing angles would enable alteration in the attitude of the carriage and height of the nozzles which in turn can alter the impact of water jets exiting nozzles. Located in carriage body 321 are high pressure water jet nozzles 325, 326 and 327. Nozzles 325, 326, 327 and 332 may be arranged to face opposite directions or alternatively the same direction depending upon debridement requirements. As shown in FIG. 14 nozzle 325 is disposed at an inclined angle relative to longitudinal axis 129 through carriage 320. Due to the geometry of the fins the carriage is also inclined relative to a longitudinal axis of a pipe (not shown) in which the carriage is placed for debridement. The attitude of the nozzles can be adjusted by facing the carriage in a opposite direction or rotating the carriage 320 degrees. Fin 323 has a wide end 330 and a narrow end 331. Each of fins also have a narrow portion 328 and a wider portion 329 which places the carriage at a predetermined angle dictated by the extent of the difference in height at one end of each fin compared to the height at the opposite end of the fin. This naturally changes the angle of repose depending on the direction that carriage 320 is facing and consequently the angle of the nozzles and the angle of the water jets exiting the nozzles. FIG. 15 shows with corresponding numbering an alternative perspective view of the embodiment of FIG. 14. FIG. 16 shows an end elevation view of the carriage of FIG. 14; and FIG. 17 shows a cross section through A-A of FIG. 16.

One advantage of the ability to angle the carriage assembly invention is that the jet passes above already cut debris so that water delivery does not impact on cut debris. Other advantages include savings in water fuel and labour costs.

Materials which may be selected for the carriage and extension legs include metals, polypropylene, silicon, urethane or other suitable mouldable materials.

Means for enabling a disposition of the angle of repose of the carriage have been described above but it will be appreciated that other means can be employed to enable a set attitude of the outlet of the nozzles to achieve the improved energy of contact and earlier or later contact with debris, scale and other unwanted material. One advantage of the ability to angle the carriage assembly invention is that the jet passes above already cut debris so that water delivery does not impact on cut debris. Other advantages include savings in water fuel and labour costs.

It will be recognised by persons skilled in the art that numerous variations and modifications may be made to the invention broadly described herein without departing from the overall spirit and scope of the invention.

1. A support carriage for receiving and retaining at least one a water delivery nozzle used in high pressure pipe cleaning, the carriage comprising:
a support body defining a space which receives and retains therein the at least one water delivery nozzle,
the carriage body including means which allows a water delivery orifice of each of the at least one nozzles to be set at a delivery angle relative to a longitudinal axis of the pipe in which the support carriage is placed, the carriage body thereby allowing a water jet exiting each said nozzles to contact an inner surface of the pipe at an angle which optimises removal of debris from the inside of the pipe under the action of the water jets.

2. A carriage according to claim 1 wherein the carriage has adjustable members which enable the attitude of the carriage to be adjusted relative to the longitudinal axis of the pipe in which the carriage is placed.

3. A carriage according to claim 2 wherein the adjustable members associated with the carriage body enable selective adjustment of the attitude of the water jets exiting the delivery nozzles.

4. A carriage according to claim 3 wherein the adjustable members engage the carriage and are repositionable to enable alteration of the angular relationship between a longitudinal axis of the pipe and a longitudinal axis of the nozzle.

5. A carriage according to claim 4 wherein the carriage is manufactured from metals

6. A carriage according to claim 5 wherein the carriage is manufactured from a plastics material.

7. A carriage according to claim 6 manufactured from plastics selected from polypropylene, polyethylene, rubbers including silicon.

8. A carriage according to claim 7 wherein the carriage is manufactured in a mould.

9. A carriage according to claim 8 wherein the material is sufficiently stiff to ensure that the nozzle is maintained in the correct attitude.

10. A carriage according to claim 9 wherein the weight of the carriage is statically balanced so the carriage stays in equilibrium irrespective of the setting of the carriage assembly.

11. A carriage according to claim 10 wherein the adjustable members contribute to nozzle tracking along the length of the pipe.

12. A carriage according to claim 11 wherein there are two turbo nozzles retained in the carriage disposed in back to back relationship

13. A carriage for receiving and retaining a water delivery nozzle, the carriage comprising:
a body defining a space which receives and retains therein the water delivery nozzle,
the carriage further comprising adjustable legs connected to the carriage body which enable selective extension and retraction of each leg to contribute to adjustment of the angle of impact of water jets emanating from the nozzle.

14. A carriage according to claim 13, wherein said extension and retraction can be achieved by legs extension, rotation of the carriage and re positioning of the carriage.

15. An assembly for use in the removal of debris, roots and other unwanted matter from the inside of a fluid pipe, the assembly comprising:
a water delivery nozzle,
a carriage for receiving and retaining a water delivery nozzle, the carriage comprising:
a carriage body defining a space which receives and retains therein the water delivery nozzle,
adjustable members associated with the carriage body enabling selective adjustment of the attitude of the delivery nozzles to thereby enable selection of an optimal angle of impact of a water jet exiting the nozzle onto debris to be removed from the pipe.

16. A method of removing debris from the inside of a fluid pipe using a high pressure water jet nozzle including;
a carriage for receiving and retaining the water delivery nozzle, the carriage comprising:
a carriage body defining a space which receives and retains therein the water delivery nozzle,
adjustable members associated with the carriage body enabling selective adjustment of the attitude of water jets delivered from the delivery nozzle;
the method comprising the steps of
a) taking the carriage and inserting a selected nozzle into the carriage;
b) selecting an attitude from the nozzle but selective adjustment to the adjustable members
c) placing the assembly inside a pipe and activating a water supply to the nozzle; wherein the selected attitude of the nozzle delivers water towards an inside surface of the pipe at an angle dictated by the selected attitude.

17. A method according to claim 16 wherein the angle at which the water jets are delivered to the pipe is selected to optimise the angle of attack of the debris sought to be removed.

18. A carriage according to claim 1 wherein the body which defines a space which receives and retains therein at least one water delivery nozzle, includes a saddle which receives and retains the nozzles on the carriage; and
a bearing surface on the carriage which allows the carriage to travel along a pipe invert during discharge of water from the at least one nozzles.

19. A carriage according to claim 18 wherein, the angle of repose of the bearing surface locates the carriage in a predetermined attitude relative to a longitudinal axis of the pipe carriage to enable selective adjustment of the angle of a water jet exiting said nozzles.

20. A carriage according to claim 19 wherein there are two turbo nozzles disposed in the carriage in back to back relationship.

21. A carriage for receiving and retaining at least one water delivery nozzle, the carriage comprising:
a body defining a space which receives and retains therein the at least one water delivery nozzle,
support means extending from the carriage body which when the carriage is inserted in a pipe engages an inner surface of the pipe,
wherein, the carriage further comprises at least one formation which enables the nozzles to be disposed at a predetermined angle relative to the longitudinal axis of the pipe in which the carriage travels.

22. A carriage according to claim 21 wherein the support means comprises at least one fin.

23. A carriage according to claim 22 the at least one fins radially extend from the carriage body.

24. A carriage according to claim 23 wherein there are three radial fins spaced apart at 120 degrees.

25. A carriage according to claim 24 wherein the formations are integral with the fins.

26. A carriage according to claim 25 wherein the formations comprise a tapered edge of each fin.

27. A carriage according to claim 26 wherein an angle of taper of taper on the tapered edge influences an angle of repose of the nozzles relative to the longitudinal axis of the pipe.

28. A carriage according to claim 27 wherein the taper angle is the same on each fin.

29. A carriage according to claim 28 wherein the carriage has a geometry which enables a fixed angular relationship between a longitudinal axis of the pipe and a longitudinal axis of the nozzle when the carriage travels along the pipe.

30. A carriage according to claim 29 wherein each said nozzles is a high pressure water delivery nozzle.

31. A carriage according to claim 30 wherein the carriage is manufactured from metals fit for the purpose.

32. A carriage according to claim 30 wherein the carriage is manufactured in a mould from plastics materials selected from polypropylene, polyethylene, rubbers including silicon.

33. An assembly for use in the removal of debris, roots and other unwanted matter from the inside of a fluid pipe, the assembly comprising:
a water delivery nozzle,
a carriage for receiving and retaining a water delivery nozzle, the carriage comprising:
a carriage body defining a space which receives and retains therein the water delivery nozzle,
a formation associated with the carriage body enabling the nozzle to be disposed in a fixed attitude so that water exiting the nozzle impacts on the inside wall of a pipe at an optimal angle for removal of debris on an inner wall of a pipe.

34. A method of removing debris from the inside of a fluid pipe using a high pressure water jet nozzle assembly comprising;
a carriage for receiving and retaining at least one water delivery nozzle, the carriage comprising:
a carriage body defining a space which receives and retains therein the at least one water delivery nozzle,
at least one radial fin on the carriage body allowing the at least one nozzles to be oriented in a predetermined attitude relative to a longitudinal axis of the pipe to thereby allow water to be delivered at predetermined angle;
the method comprising the steps of
a) taking the carriage and inserting at least one nozzle into the carriage so that the at least one nozzle lies at the predetermined angle;
b) placing the assembly inside a pipe and activating a water supply to the nozzle; wherein the selected attitude of the nozzle delivers water towards an inside surface of the pipe at an angle dictated by the selected attitude.

35. A method according to claim 34 comprising the further step of providing a plurality of radially disposed fins on the carriage having a geometry which optimises the angle of attack of a water jet for removal of debris from inside the pipe.
